(19) United States
(12) Patent Application Publication
(10) Pub. No.: US 2024/0030614 A1
(43) Pub. Date: Jan. 25, 2024

(54) ANTENNA MODULE

(71) Applicant: Murata Manufacturing Co., Ltd., Nagaokakyo-shi (JP)

(72) Inventors: Hayato NAKAMURA, Nagaokakyo-shi (JP); Kaoru SUDO, Nagaokakyo-shi (JP); Kengo ONAKA, Nagaokakyo-shi (JP)

(73) Assignee: Murata Manufacturing Co., Ltd., Nagaokakyo-shi (JP)

(21) Appl. No.: 18/481,238

(22) Filed: Oct. 5, 2023

Related U.S. Application Data
(63) Continuation of application No. PCT/JP2022/010274, filed on Mar. 9, 2022.

(30) Foreign Application Priority Data
Apr. 9, 2021 (JP) 2021-066454

(51) Int. Cl. H01Q 13/10; H01Q 13/08; H01Q 1/38; H01Q 1/50

(52) U.S. Cl. CPC H01Q 13/10; H01Q 13/08; H01Q 1/38; H01Q 1/50

(57) ABSTRACT

In a first region of a ground electrode, a width of a protrusion of the ground electrode in a first direction, in which a notch portion is formed, from a slot is different from a width of the ground electrode in a second direction opposite to the first direction from the slot.

### CROSS-REFERENCE TO RELATED APPLICATIONS

This is a continuation application of PCT/JP2022/010274, filed on Mar. 9, 2022, designating the United States of America, which is based on and claims priority to Japanese Patent Application No. JP 2021-066454 filed on Apr. 9, 2021. The entire contents of the above-identified applications, including the specifications, drawings and claims, are incorporated herein by reference in their entirety.

### TECHNICAL FIELD

The present disclosure relates to an antenna module.

### BACKGROUND ART

Japanese Unexamined Patent Application Publication No. 2000-68731 (Patent Document 1) discloses a slot-loop antenna in which a conductive layer is arranged on the undersurface of a substrate and which is configured to reflect radio waves transmitted or received by the resonant structure of the antenna. In this slot-loop antenna, a resonant slot and a ground wire are provided in the same plane on the same substrate. In this slot-loop antenna, connecting wires outside the antenna are connected from the direction of one side face of the substrate, and thus the ground wire is arranged in an asymmetric manner in that direction.

### CITATION LIST

### Patent Document

Patent Document 1: Japanese Unexamined Patent Application Publication No. 2000-68731

### SUMMARY

### Technical Problem

However, an existing antenna module as in Patent Document 1 has a ground wire arranged in an asymmetric manner in a particular direction and thus has a problem in that the symmetry of the radiation characteristics of radio waves deteriorates.

The present disclosure has been made to solve the above-described problem, and a purpose of the present disclosure is to improve the symmetry of the radiation characteristics of radio waves.

### Solution to Problem

An antenna module according to an aspect of the present disclosure includes a first dielectric substrate, a first ground electrode, and a first power supply line. The first dielectric substrate is planar. The first ground electrode is provided on the first dielectric substrate and in which a first slot and a first notch portion are formed, the first notch portion extending in a first direction from the first slot. The first power supply line is arranged at an identical position to the first ground electrode in a direction of thickness of the first dielectric substrate. The first ground electrode has a first protrusion projecting between the first slot and the first notch portion. A width of the first protrusion in the first direction is different from a width of the first ground electrode in a second direction opposite to the first direction.

An antenna module according to another aspect of the present disclosure includes a first dielectric substrate, a first ground electrode, a first radiating element, and a first power supply line. The first dielectric substrate is planar. The first ground electrode is provided on the first dielectric substrate and in which a first slot and a first notch portion are formed, the first notch portion extending in a first direction from the first slot. The first radiating element is arranged in the first slot. The first power supply line is provided on the first dielectric substrate, extends through the first notch portion in the first direction, and transfers a radio frequency signal to the first radiating element. The first power supply line is arranged at an identical position to the first ground electrode in a direction of thickness of the first dielectric substrate. A distance between the first ground electrode and the first radiating element in the first direction from the first radiating element is different from a distance between the first ground electrode and the first radiating element in a second direction opposite to the first direction.

### Effects

According to an antenna module according to the aspect of the present disclosure, a first slot and a first notch portion, which extends from the first slot in a first direction, are formed in a first ground electrode. The first ground electrode has a first protrusion projecting between the first slot and the first notch portion. A width of the first protrusion in the first direction is different from a width of the first ground electrode in a second direction opposite to the first direction, and thus the radiation characteristics of radio waves to be radiated are adjusted. As a result, the symmetry of the radiation characteristics of radio waves to be radiated can be improved.

According to an antenna module according to the other aspect of the present disclosure, a first slot and a first notch portion, which extends from the first slot in a first direction, are formed in a first ground electrode. A distance between the first ground electrode and a first radiating element, which is arranged in the first slot, in the first direction from the first radiating element is different from a distance between the first ground electrode and the first radiating element in a second direction opposite to the first direction, and thus the radiation characteristics of radio waves to be radiated are adjusted. As a result, the symmetry of the radiation characteristics of radio waves to be radiated can be improved.

### BRIEF DESCRIPTION OF DRAWINGS

FIG. 1 is an example of a block diagram of a communication device 10 according to a first embodiment.

FIG. 2 includes a plan view and a side perspective view of a first example of an antenna element 2 in the first embodiment.

FIG. 3 is an enlarged view of a ground electrode 21,24 and a power supply line 22,23 each of which is viewed in a plan view from the positive direction of the Z axis in the first embodiment and a second embodiment.

FIG. 4 includes a plan view and a side perspective view of a second example of the antenna element 2 in the second embodiment.

FIG. 5 is a plan view of antenna elements 2A1 and 2A2 illustrating a first example of an arrayed structure of antenna elements 2A in a third embodiment.

FIG. 6 is a plan view of antenna elements 2B1 and 2B2 illustrating a first example of an arrayed structure of antenna elements 2B in a fourth embodiment.

FIG. 7 includes a plan view and a side perspective view of an example of connection between the antenna element 2A and a wiring line portion 300 in a fifth embodiment.

FIG. 8 includes a plan view and a side perspective view of an example of connection between the antenna element 2B and the wiring line portion 300 in a sixth embodiment.

FIG. 9 is a plan view of the antenna elements 2A1 and 2A2 illustrating a second example of the arrayed structure of the antenna elements 2A in a seventh embodiment.

FIG. 10 is a plan view of the antenna elements 2B1 and 2B2 illustrating a second example of the arrayed structure of the antenna elements 2B in an eighth embodiment.

### DESCRIPTION OF EMBODIMENTS

In the following, embodiments of the present disclosure will be described in detail with reference to the drawings. Identical or equivalent parts in the drawings are denoted by the same symbols and description thereof is not repeated.

### First Embodiment

### Basic Configuration of Communication Device

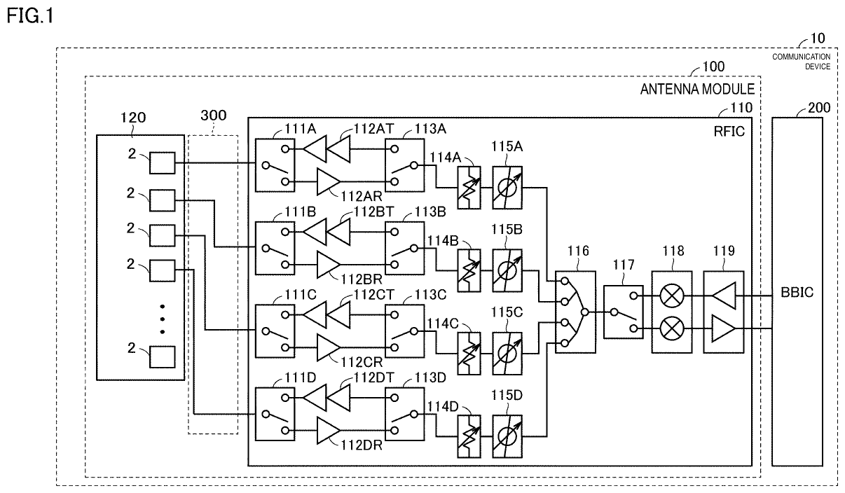

FIG. 1 is an example of a block diagram of a communication device 10 according to a first embodiment.

The communication device 10 is, for example, a portable terminal such as a cellular phone, a smartphone, or a tablet, a personal computer having a communication function, or a base station. Examples of a frequency band of radio waves used in an antenna module 100 in the first embodiment include radio waves of millimeter wavebands with center frequencies of 28 GHz, 39 GHz, and 60 GHz, for example; however, radio waves in frequency bands other than the above-described wavebands can also be applied.

With reference to FIG. 1, the communication device 10 includes the antenna module 100 and a baseband integrated circuit (BBIC) 200, which constitutes a baseband signal processing circuit. The antenna module 100 includes a radio-frequency integrated circuit (RFIC) 110, which is an example of a power supply circuit, and an antenna device 120. The communication device 10 up-converts, at the RFIC 110, a signal transferred from the BBIC 200 to the antenna module 100 into a radio frequency signal and radiates the radio frequency signal from the antenna device 120 through a wiring line portion 300. The communication device 10 transfers a radio frequency signal received by the antenna device 120 to the RFIC 110 through the wiring line portion 300, down-converts the radio frequency signal, and then processes the resulting signal at the BBIC 200.

In FIG. 1, for ease of description, only five antenna elements 2 among a plurality of antenna elements 2 included in the antenna device 120 are illustrated, and the other antenna elements 2 having the similar configurations are omitted. Note that FIG. 1 illustrates an example of the configuration of the antenna device 120, in which the plurality of antenna elements 2 are arranged in a one-dimension array; however, the antenna device 120 does not necessarily need to have a plurality of antenna elements 2 and may be configured such that a single antenna element 2 is formed. Moreover, the antenna device 120 may be configured such that the antenna elements 2 are arranged in a two-dimensional array.

The RFIC 110 includes switches 111A to 111D, 113A to 113D, and 117, power amplifiers 112AT to 112DT, low noise amplifiers 112AR to 112DR, attenuators 114A to 114D, phase shifters 115A to 115D, a signal multiplexer/demultiplexer 116, a mixer 118, and an amplifier circuit 119.

In a case where a radio frequency signal is to be transmitted, the switches 111A to 111D and 113A to 113D are switched to the power amplifier sides 112AT to 112DT, and the switch 117 is connected to a transmission side amplifier of the amplifier circuit 119. In a case where a radio frequency signal is to be received, the switches 111A to 111D and 113A to 113D are switched to the low noise amplifier sides 112AR to 112DR, and the switch 117 is connected to a reception side amplifier of the amplifier circuit 119.

The signal transferred from the BBIC 200 is amplified at the amplifier circuit 119 and is up-converted at the mixer 118. The up-converted radio frequency signal, which is a transmission signal, is split into four signals by the signal multiplexer/demultiplexer 116. The four signals pass through four signal paths and are fed to different antenna elements 2 in a respective manner. In this case, the directivity of the antenna device 120 can be adjusted by individually adjusting the phases of the phase shifters 115A to 115D arranged in the respective signal paths. The attenuators 114A to 114D adjust the strengths of transmission signals.

Reception signals, which are radio frequency signals received by the respective antenna elements 2, are routed through the four different signal paths in a respective manner and are combined at the signal multiplexer/demultiplexer 116. The combined reception signal is down-converted at the mixer 118, is amplified at the amplifier circuit 119, and is then transferred to the BBIC 200.

The RFIC 110 is, for example, formed as a single-chip integrated circuit component including the above-described circuit configuration. Alternatively, devices (a switch, a power amplifier, a low noise amplifier, an attenuator, a phase shifter) corresponding to each antenna element 2 in the RFIC 110 may be formed as a single-chip integrated circuit component on the corresponding antenna element 2.

### Structure of First Example of Antenna Elements 2

Next, the structure of a first example will be described in which slot-type antenna elements 2A are used as the antenna elements 2 in the antenna module 100 illustrated in FIG. 1.

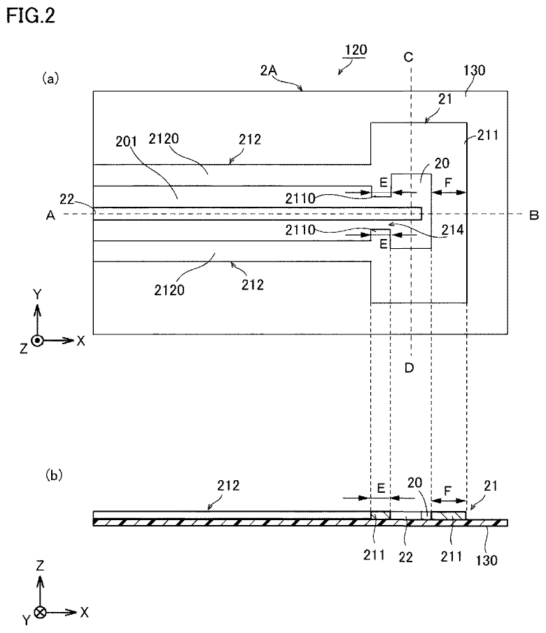

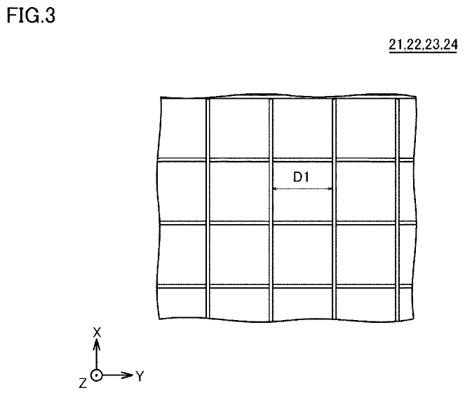

FIG. 2 includes a plan view (FIG. 2(a)) and a side perspective view (FIG. 2(b)) of the first example of an antenna element 2 in the first embodiment. FIG. 3 is an enlarged view of ground electrodes 21 and 24 and power supply lines 22 and 23 each of which is viewed in a plan view from the positive direction of the Z axis in the first embodiment and a second embodiment.

In the following description, the direction of thickness of the antenna element 2 is treated as the Z axis, and a plane perpendicular to the Z axis is defined by the X axis and the Y axis. In the drawings, the X axis, the Y axis, and the Z axis are illustrated as needed.

With reference to FIG. 2, the first example of each antenna element 2 in the antenna device 120 is a slot-type antenna element 2A. The antenna element 2A includes a ground electrode 21 and a power supply line 22 formed on a dielectric substrate 130.

The dielectric substrate 130 is composed of a planar dielectric substrate. More specifically, the dielectric substrate 130 is a substrate having translucency. Further more specifically, the dielectric substrate 130 is a transparent film substrate. For example, the dielectric substrate 130 is a single layer substrate composed of a polyethylene terephthalate (PET) material. Note that the dielectric substrate 130 may be a multilayer resin substrate formed by laminating a plurality of resin layers or any multilayer ceramic substrate without using low-temperature cofired ceramic (LTCC). Moreover, the dielectric substrate 130 may be formed of glass or plastic.

The ground electrode 21 is provided on the dielectric substrate 130 and has a slot 20 and a notch portion 201 formed therein, the notch portion 201 extending in a direction from the slot 20 to an end portion of the dielectric substrate 130. Specifically, the ground electrode 21 has the following configuration. The ground electrode 21 includes a first region 211 and a second region 212. In the first region 211, the slot 20, which is square shaped, is formed. In the second region 212, the notch portion 201 extending from the first region 211 to the end portion of the dielectric substrate 130 is formed. In the first region 211, an opening 214 is formed through which a portion of the slot 20 is open in the direction to the notch portion 201 of the second region 212.

The ground electrode 21 has protrusions 2110, which project between the slot 20 and the notch portion 201. Specifically, in the first region 211, the protrusions 2110, which are a pair of protrusions, projecting into the opening 214 are formed so as to face each other at opening end portions facing the opening 214. The protrusions 2110 are regions needed to improve the function of the slot 20. Note that the ground electrode 21 may or may not have only one protrusion out of the pair of protrusions 2110.

The second region 212 includes, on the dielectric substrate 130, a pair of electrode paths 2120 formed in parallel with each other so as to extend along both sides of the notch portion 201 extending from the end portion of the dielectric substrate 130 to the first region 211.

The power supply line 22 transfers radio frequency signals into the slot 20. The power supply line 22 is provided on the dielectric substrate 130 and extends through the notch portion 201 in the direction to the slot 20. Specifically, the power supply line 22 is configured as follows. The power supply line 22 is arranged in the notch portion 201 surrounded by the second region 212 on the dielectric substrate 130 and is formed so as to have a shape that extends from the end portion of the dielectric substrate 130 through the notch portion 201 and the opening 214 and into the slot 20. The power supply line 22 is arranged at an identical position to the ground electrode 21 in the direction of thickness of the dielectric substrate 130. That is, the power supply line 22 and the ground electrode 21 are arranged on the same surface of the dielectric substrate 130. Note that, in a case where the dielectric substrate 130 is a multilayer substrate, the power supply line 22 and the ground electrode 21 may be arranged in the same layer.

At the end portion of the dielectric substrate 130, the second region 212 of the ground electrode 21 and the power supply line 22 are connected to a ground electrode and a power supply line formed in the wiring line portion 300.

As illustrated in FIG. 3, each of the ground electrode 21 and the power supply line 22 has a mesh shape when viewed in a plan view from the positive direction of the Z axis, that is, the normal direction of the dielectric substrate 130. With reference to FIG. 3, the mesh shape of each of the ground electrode 21 and the power supply line 22 will be described. Each of the ground electrode 21 and the power supply line 22 is formed by arranging conductor wiring lines in a grid pattern. Regarding such wiring lines in a grid pattern, the angles at which the wiring lines intersect need not be right angles. A distance D1 between wiring lines for such conductor wiring lines is, for example, greater than or equal to 50 μm and less than or equal to 100 μm. The width of each conductor wiring line is, for example, greater than or equal to 1 μm and less than or equal to 2 μm.

Each of the ground electrode 21 and the power supply line 22 is formed by arranging conductor wiring lines in a grid pattern. Thus, the ground electrode 21 and the power supply line 22 do not block most of light radiated from the negative direction side of the Z axis and allow most of the light to pass therethrough to the positive direction side of the Z axis. As a result, the ground electrode 21 and the power supply line 22 have configurations with translucency in the antenna element 2A, and it is difficult to confirm their presence with the naked eye.

As described above, since the dielectric substrate 130 is in the form of a transparent film in the antenna element 2A, it is possible to make it difficult to confirm the presence of the dielectric substrate 130 with the naked eye. Moreover, since the ground electrode 21 and the power supply line 22 in the antenna element 2A are configured so as to have mesh shapes that make it difficult to confirm their presence with the naked eye, it is possible to make it difficult to confirm the presence of the ground electrode 21 and the power supply line 22 with the naked eye. Moreover, the antenna element 2A has overall translucency since the dielectric substrate 130, the ground electrode 21, and the power supply line 22 have translucency, so that it is possible to make it difficult to confirm the presence of the entirety of the antenna element 2A with the naked eye. As a result, the antenna element 2A is suitable for installation in devices and the like where it is desired that the presence of the antenna element 2A should not be visible to a user.

The side perspective view in FIG. 2(b) illustrates a state of the ground electrode 21 obtained by cutting the antenna element 2A in the Z-axis direction along a plane parallel to a line segment AB at the position where the protrusions 2110 are formed. With reference to FIG. 2, regarding radio waves to be radiated from the antenna element 2A, radiation characteristics in the Z-axis direction, which is the normal direction of the dielectric substrate 130, are desired. In FIG. 2, when the line segment AB passing along the center line of the power supply line 22 in the extension direction of the power supply line 22 is used as the axis of line symmetry, the ground electrode 21 and the power supply line 22, which are conductors, are symmetrical in shape in two regions separated by that axis. Thus, the radio waves radiated from the slot 20 can ensure symmetry of the radiation characteristics of radio waves in the Z-axis direction when the line segment AB is used as the axis of line symmetry.

The reason for this is that even though the radiation characteristics of radio waves may be affected by the ground electrode 21 and the power supply line 22, when the shapes of the ground electrode 21 and the power supply line 22, which are divided into two regions by the line segment AB serving as the axis of line symmetry, are symmetrical in both the regions, the radiation characteristics of radio waves in the Z-axis direction are affected by the conductors in both the regions separated by the line segment AB, and thus the effects received from the conductors in both the regions on the radiation characteristics in the Z-axis direction are offset.

In contrast, in FIG. 2, when a line segment CD passing along the center line of the slot 20 in the direction perpendicular to the extension direction of the power supply line 22 is used the axis of line symmetry, the ground electrode 21 and the power supply line 22 are not symmetrical in shape in the two regions separated by that axis. Thus, simply in terms of symmetry of shape, it is considered that radio waves to be radiated from the slot 20 will have difficulty in ensuring symmetry of the radiation characteristics of radio waves in the Z-axis direction when the line segment CD is used as the axis of linear symmetry.

Specifically, as in FIG. 2, in the antenna element 2A having a configuration in which the power supply line 22 has a shape starting from the end portion of the dielectric substrate 130 and extending on the dielectric substrate 130, the shape of the ground electrode 21 on the second region 212 side of the slot 20 and the shape of the ground electrode 21 on the opposite side from the second region 212 of the slot 20 are necessarily different. Thus, due to these differences in the shape and size of the ground electrode 21 on both sides of the slot 20, the radiation direction of radio waves radiated from the slot 20 is considered to be tilted in either a direction toward A or a direction toward B with respect to the line segment CD serving as the axis.

Thus, in order to obtain symmetry in the radiation characteristics of radio waves to be radiated from the slot 20 in the Z-axis direction when the line segment CD is used as the axis of line symmetry, a width E of the ground electrode 21 in a first direction, in which the notch portion 201 is formed, from the slot 20 and a width F of the ground electrode 21 in a second direction opposite to the first direction from the slot 20 are made different. More specifically, the ground electrode 21 is formed such that the width E of the ground electrode 21 in the first direction from the slot 20 when the direction from the slot 20 to the notch portion 201 is treated as the first direction is different from the width F of the ground electrode 21 in the second direction from the slot 20 when the direction opposite to the first direction is treated as the second direction. More specifically, the width E of the ground electrode 21 is the width of each protrusion 2110 of the ground electrode 21 in the first direction from the slot 20. The width F of the ground electrode 21 is the width of the ground electrode 21 in the second direction from the slot 20.

When the width E of the protrusion 2110 of the ground electrode 21 in the first direction from the slot 20 is different from the width F of the ground electrode 21 in the second direction from the slot 20, regarding radio waves to be radiated from the slot 20, it is possible to adjust the effects of the conductors in the two regions separated by the line segment CD on the radiation characteristics of the radio waves in the Z-axis direction. By making the width E of the protrusion 2110 of the ground electrode 21 and the width F of the ground electrode 21 different from each other, even in a case where there is no symmetry regarding the shapes of the ground electrode 21 and the power supply line 22, the symmetry of the radiation characteristics of radio waves in the Z-axis direction can be improved for radio waves to be radiated.

Thus, even in a case where the shape of the ground electrode 21 for one region of the slot 20 separated by the line segment CD is different from that of the ground electrode 21 for the other region, the symmetry of the radiation characteristics of radio waves can be improved for any ground electrode shape by performing adjustments to make the width E of the protrusion 2110 of the ground electrode 21 and the width F of the ground electrode 21 different from each other.

The length of the slot 20 in the line segment CD direction is set to “λ/2” when the wavelength of radio waves to be radiated is λ. It is sufficient that a standard value of the width F be set to “λ” in the first embodiment. Note that the standard value of the width F may be set to an integer multiple of “λ” in the first embodiment; however, the width F need not be too long, and it is sufficient that the width F be set to at least an integer multiple of “λ”.

### Second Embodiment

### Structure of Second Example of Antenna Elements 2

In the second embodiment, the structure of a second example will be described in which patch-type antenna elements 2B are used as the antenna elements 2 in the antenna module 100 illustrated in FIG. 1.

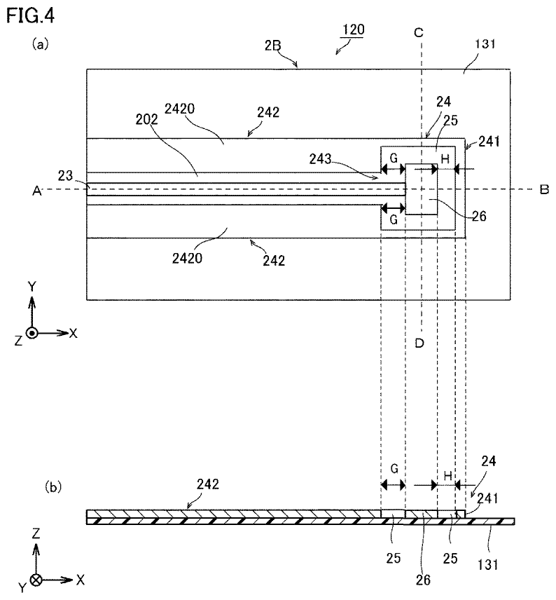

FIG. 4 includes a plan view (FIG. 4(a)) and a side perspective view (FIG. 4(b)) of the second example of the antenna element 2 in the second embodiment.

With reference to FIG. 4, the second example of the antenna element 2 in the antenna device 120 is a patch-type antenna element 2B. The dielectric substrate 131 is composed of a planar dielectric substrate. More specifically, the dielectric substrate 131 is a substrate having translucency. Further more specifically, the dielectric substrate 131 is a transparent film substrate. The antenna element 2B includes the ground electrode 24, a patch 26, and the power supply line 23 formed on the dielectric substrate 131. The patch 26 is a radiating element that has characteristics of radiating radio waves.

The ground electrode 24 is provided on the dielectric substrate 131 and has a slot 25 and a notch portion 202 formed therein, the notch portion 202 extending in a direction from the slot 25 to an end portion of the dielectric substrate 131. Specifically, the ground electrode 24 has the following configuration. The ground electrode 24 includes a first region 241 and a second region 242. In the first region 241, the slot 25, which is square shaped, is formed. In the second region 242, the notch portion 202 extending from the first region 241 to the end portion of the dielectric substrate 131 is formed. In the first region 241, an opening 243 is formed in a portion of the slot 25, in which the patch 26 is provided, and the slot 25 is open in the direction to the second region 242.

On the dielectric substrate 131, the patch 26 having a rectangular shape is arranged in the slot 25 surrounded by the first region 241. In other words, the first region 241 of the ground electrode 24 is formed so as to surround the patch 26.

In the first region 241, protrusions as illustrated in FIG. 2 are not formed at the opening end portions facing the opening 243. However, protrusions as illustrated in FIG. 2 may be formed at the opening end portions facing the opening 243 in the first region 241.

The second region 242 includes, on the dielectric substrate 131, a pair of electrode paths 2420 formed in parallel with each other and having a shape surrounding both sides of the notch portion 202 extending from the end portion of the dielectric substrate 131 to the first region 241.

The power supply line 23 transfers radio frequency signals to the patch 26. The power supply line 23 is provided on the dielectric substrate 131 and extends through the notch portion 202 in the direction to the slot 25. Specifically, the power supply line 23 is configured as follows. The power supply line 23 is arranged in the notch portion 202 surrounded by the second region 242 on the dielectric substrate 131 and is formed so as to have a shape that extends from the end portion of the dielectric substrate 131 through the notch portion 202 and the opening 243 and is connected inside the patch 26. The power supply line 23 is arranged at an identical position to the ground electrode 24 in the direction of thickness of the dielectric substrate 131.

At the end portion of the dielectric substrate 131, the second region 242 of the ground electrode 24 and the power supply line 23 are connected to the ground electrode and the power supply line formed in the wiring line portion 300.

As illustrated in FIG. 3, each of the ground electrode 24 and the power supply line 23 has a mesh shape when viewed in a plan view from the positive direction of the Z axis, that is, the normal direction of the dielectric substrate 131. With reference to FIG. 3, the mesh shape of each of the ground electrode 24 and the power supply line 23 will be described. Each of the ground electrode 24 and the power supply line 23 is formed by arranging conductor wiring lines in a grid pattern. Regarding such wiring lines in a grid pattern, the angles at which the wiring lines intersect need not be right angles. A distance D1 between wiring lines for such conductor wiring lines is, for example, greater than or equal to 50 μm and less than or equal to 100 μm. The width of each conductor wiring line is, for example, greater than or equal to 1 μm and less than or equal to 2 μm.

Each of the ground electrode 24 and the power supply line 23 is formed by arranging conductor wiring lines in a grid pattern. Thus, the ground electrode 24 and the power supply line 23 do not block most of light radiated from the negative direction side of the Z axis and allow most of the light to pass therethrough to the positive direction side of the Z axis. As a result, the ground electrode 24 and the power supply line 23 have configurations with translucency in the antenna element 2B, and it is difficult to confirm their presence with the naked eye.

As described above, since the dielectric substrate 131 is in the form of a transparent film in the antenna element 2B, it is possible to make it difficult to confirm the presence of the dielectric substrate 131 with the naked eye. Moreover, since the ground electrode 24 and the power supply line 23 in the antenna element 2B are configured so as to have mesh shapes that make it difficult to confirm their presence with the naked eye, it is possible to make it difficult to confirm the presence of the ground electrode 24 and the power supply line 23 with the naked eye. Moreover, the antenna element 2B has overall translucency since the dielectric substrate 131, the ground electrode 24, and the power supply line 23 have translucency, so that it is possible to make it difficult to confirm the presence of the entirety of the antenna element 2B with the naked eye. As a result, the antenna element 2B is suitable for installation in devices and the like where it is desired that the presence of the antenna element 2B should not be confirmed with the naked eye.

The side perspective view in FIG. 4(b) illustrates a state of the ground electrode 24 obtained by cutting the antenna element 2B in the Z-axis direction along a plane parallel to a line segment AB at a position where the second region 242 is formed. With reference to FIG. 4, regarding radio waves to be radiated from the antenna element 2B, radiation characteristics in the Z-axis direction, which is the normal direction of the dielectric substrate 131, are desired. In FIG. 4, when the line segment AB passing along the center line of the power supply line 23 in the extension direction of the power supply line 23 is used the axis of line symmetry, the ground electrode 24 and the power supply line 23, which are conductors, are symmetrical in shape in two regions separated by that axis. Thus, the radio waves radiated from the patch 26 can ensure symmetry of the radiation characteristics of radio waves in the Z-axis direction when the line segment AB is used as the axis of line symmetry.

The reason for this is that even though the radiation characteristics of radio waves may be affected by the ground electrode 24 and the power supply line 23, when the shapes of the ground electrode 24 and the power supply line 23, which are divided into two regions by the line segment AB serving as the axis of line symmetry, are symmetrical in both the regions, the radiation characteristics of radio waves in the Z-axis direction are affected by the conductors in both the regions separated by the line segment AB, and thus the effects received from the conductors in both the regions on the radiation characteristics in the Z-axis direction are offset.

In contrast, in FIG. 4, when a line segment CD passing along the center line of the patch 26 on the XY plane perpendicular to the extension direction of the power supply line 23 is used as the axis of line symmetry, the ground electrode 24 and the power supply line 23 are not symmetrical in shape in the two regions separated by that axis. Thus, simply in terms of symmetry of shape, it is considered that radio waves to be radiated from the patch 26 will have difficulty in ensuring symmetry of the radiation characteristics of radio waves in the Z-axis direction when the line segment CD is used as the axis of linear symmetry.

Specifically, as in FIG. 4, in the antenna element 2B having a configuration in which the power supply line 23 has a shape starting from the end portion of the dielectric substrate 131 and extending on the dielectric substrate 131, the shape of the ground electrode 24 on the second region 242 side of the patch 26 and the shape of the ground electrode 24 on the opposite side from the second region 242 of the patch 26 are necessarily different. Thus, due to these differences in the shape and size of the ground electrode 24 on both the sides of the patch 26, the radiation direction of radio waves radiated from the patch 26 is considered to be tilted in either the direction toward A or the direction toward B with respect to the line segment CD serving as the axis.

Thus, in order to obtain symmetry in the radiation characteristics of radio waves to be radiated from the patch 26 in the Z-axis direction when the line segment CD is used as the axis of line symmetry, a distance G between the patch 26 and the ground electrode 24 in a first direction, in which the notch portion 202 is formed, from the patch 26 and a distance H between the patch 26 and the ground electrode 24 in a second direction opposite to the first direction from the patch 26 are made different. More specifically, the ground electrode 24 is formed such that the distance G between the patch 26 and the ground electrode 24 in the first direction when the direction from the patch 26 to the notch portion 202 is treated as the first direction is different from the distance H between the patch 26 and the ground electrode 24 in the second direction from the patch 26 when the direction opposite to the first direction is treated as the second direction.

When the distance G between the patch 26 and the ground electrode 24 in the first direction from the patch 26 is different from the distance H between the patch 26 and the ground electrode 24 in the second direction from the patch 26, regarding radio waves to be radiated from the patch 26, it is possible to adjust the effects of the conductors in the two regions separated by the line segment CD on the radiation characteristics of the radio waves in the Z-axis direction. By making the distance G and the distance H different from each other, even in a case where there is no symmetry regarding the shapes of the ground electrode 24 and the power supply line 23, the symmetry of the radiation characteristics of radio waves in the Z-axis direction can be improved for radio waves to be radiated.

Thus, even in a case where the shape of the ground electrode 24 for one region of the patch 26 separated by the line segment CD is different from that of the ground electrode 24 for the other region, the symmetry of the radiation characteristics of radio waves can be improved for any ground electrode shape by performing adjustments to make the distance G between the patch 26 and the ground electrode 24 in the first direction from the patch 26 and the distance H between the patch 26 and the ground electrode 24 in the second direction from the patch 26 different from each other.

The length of the patch 26 in the line segment CD direction is set to “λ/2” when the wavelength of radio waves to be radiated is λ. It is sufficient that a standard value of the distance H be set to “λ” in the second embodiment. Note that the standard value of the distance H may be set to an integer multiple of “λ” in the second embodiment; however, the distance H need not be too long, and it is sufficient that the distance H be set to at least an integer multiple of “λ”.

### Third Embodiment

### First Example of Arrayed Structure of Antenna Elements 2A

In a third embodiment, a first example of an arrayed structure of antenna elements 2A illustrated in FIG. 2 will be described.

FIG. 5 is a plan view of antenna elements 2A1 and 2A2 illustrating the first example of the arrayed structure of the antenna elements 2A in the third embodiment. FIG. 5 illustrates a typical example of a structure in which two adjacent antenna elements 2A, 2A1 and 2A2, are arrayed such that the slots 20 are oriented in the same direction. The dashed line is illustrated in the drawing to clarify the two antenna elements 2A1 and 2A2 as individual antenna element units.

Referring to FIG. 5, in the case of the first example of the structure in which a plurality of antenna elements 2A are arrayed, regarding the antenna elements 2A1 and 2A2 to be arrayed, parts of the ground electrodes 21 illustrated in FIG. 2 are formed so as to be integrated with each other to form a ground electrode portion 215. Specifically, the ground electrode portion 215 is formed by forming the facing first regions 211 so as to be integrated with each other and the facing second regions 212 so as to be integrated with each other between the adjacent antenna elements 2A1 and 2A2.

In a case where a plurality of antenna elements 2A are arrayed as illustrated in FIG. 5, the following effects can be achieved. The array of the plurality of antenna elements 2A can suppress, over a wide range, noise radiated from elements and circuits provided in the downward direction from the arrayed antenna elements 2A. In a case where a plurality of antenna elements 2A are arrayed, the size of the array of the plurality of antenna elements 2A can be reduced by forming the ground electrode portion 215, which is formed by forming the first regions 211 so as to be integrated with each other and the second regions 212 so as to be integrated with each other. In a case where a plurality of antenna elements 2A are arrayed, the array can be formed on a single layer of the dielectric substrate 130, thus reducing an increase in the thickness of the device when a plurality of antenna elements 2A are formed.

### Fourth Embodiment

### First Example of Arrayed Structure of Antenna Elements 2B

In a fourth embodiment, a first example of an arrayed structure of antenna elements 2B illustrated in FIG. 4 will be described.

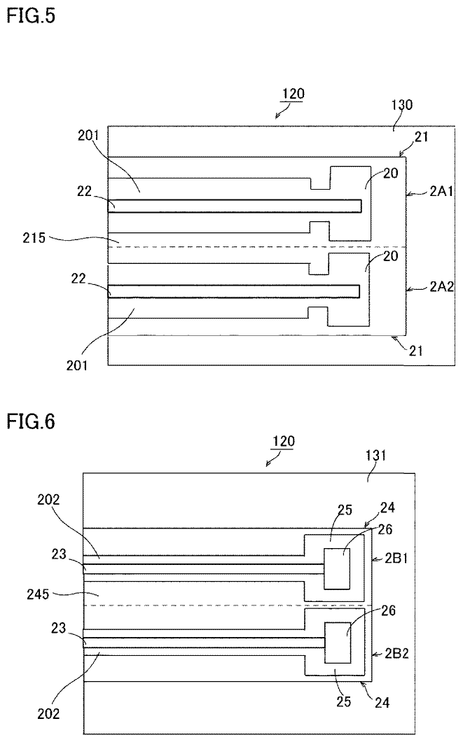

FIG. 6 is a plan view of antenna elements 2B1 and 2B2 illustrating the first example of the arrayed structure of the antenna elements 2B in the fourth embodiment. FIG. 6 illustrates a typical example of a structure in which two adjacent antenna elements 2B, 2B1 and 2B2, are arrayed such that the patches 26 are oriented in the same direction. The dashed line is illustrated in the drawing to clarify the two antenna elements 2B1 and 2B2 as individual antenna element units.

Referring to FIG. 6, in the case of the first example of the structure in which a plurality of antenna elements 2B are arrayed, regarding the antenna elements 2B1 and 2B2 to be arrayed, parts of the ground electrodes 24 illustrated in FIG. 4 are formed so as to be integrated with each other to form a ground electrode portion 245. Specifically, the ground electrode portion 245 is formed by forming the facing first regions 241 so as to be integrated with each other and the facing second regions 242 so as to be integrated with each other between the adjacent antenna elements 2B1 and 2B2.

In a case where a plurality of antenna elements 2B are arrayed as illustrated in FIG. 6, the following effects can be achieved. The array of the plurality of antenna elements 2B can suppress, over a wide range, noise radiated from elements and circuits provided in the downward direction from the arrayed antenna elements 2B. In a case where a plurality of antenna elements 2B are arrayed, the array of the plurality of antenna elements 2B can reduce the size of the array by forming the ground electrode portion 245, which is formed by forming the first regions 241 so as to be integrated with each other and the second regions 242 so as to be integrated with each other. In a case where a plurality of antenna elements 2B are arrayed, the array can be formed on a single layer of the dielectric substrate 131, thus reducing an increase in the thickness of the device when a plurality of antenna elements 2B are formed.

### Fifth Embodiment

### Example of Connection Between Antenna Element 2A and Wiring Line Portion 300

In a fifth embodiment, an example of connection between the antenna element 2A illustrated in FIG. 2 and the wiring line portion 300 illustrated in FIG. 1 will be described.

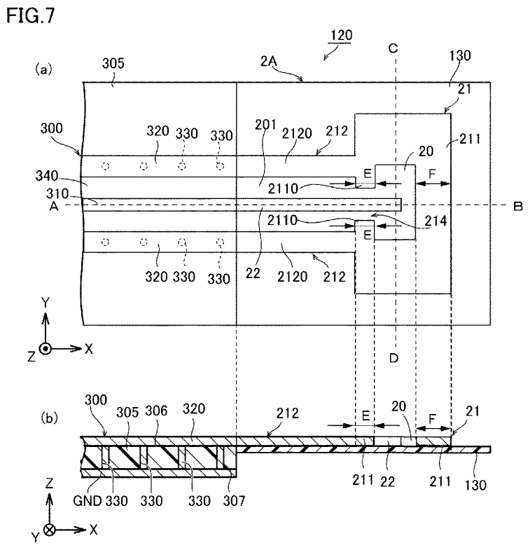

FIG. 7 includes a plan view (FIG. 7(a)) and a side perspective view (FIG. 7(b)) of an example of connection between the antenna element 2A and the wiring line portion 300 in the fifth embodiment. The side perspective view in FIG. 7(b) is a side perspective view in the Y direction in the drawing, the side perspective view being obtained by cutting the antenna element 2A and the wiring line portion 300 in the Z-axis direction along a plane parallel to the line segment AB at a position where columnar electrodes 330 are formed on a ground electrode 320 in the rear part in the Y direction in the wiring line portion 300.

The wiring line portion 300 is formed on a dielectric substrate separate from the antenna element 2A. The wiring line portion 300 includes a dielectric layer 305, a power supply line 310, a pair of ground electrodes 320, and a ground electrode GND. The dielectric layer 305 is a dielectric substrate formed of, for example, liquid crystal polymer (LCP). The dielectric layer 305 functions as a flexible cable with flexibility. The wiring line portion 300 does not have translucency. The pair of ground electrodes 320 are shaped electrodes with a notch portion 340 extending in the direction of extension of the pair of ground electrodes 320. In this manner, the pair of ground electrodes 320 constitute two electrode paths.

The ground electrode GND is arranged on a bottom surface 307 of the dielectric layer 305. The power supply line 310 and the pair of ground electrodes 320 extending along both sides of the power supply line 310 are arranged on a top surface 306 of the dielectric layer 305. Each ground electrode 320 is connected to the ground electrode GND by a plurality of columnar electrodes (vias) 330.

The power supply line 310 and the ground electrodes 320 form coplanar lines. Note that the power supply line 310 and the ground electrode GND may be used to form a strip line. Moreover, the power supply line 310 and the ground electrode GND may be used to form a microstrip line. By forming such coplanar lines, such a strip line, or such a microstrip line, high-speed transmission lines can be formed.

The wiring line portion 300 is arranged such that one end of the dielectric layer 305 in the direction of extension of the power supply line 310 faces an end face of the dielectric substrate 130 of the antenna device 120.

In the wiring line portion 300, the top surface 306 of the dielectric layer 305 is arranged at a position where the top surface 306 coincides with the top surface of the dielectric substrate 130. As a result, the power supply line 310 and the ground electrodes 320 are arranged at an identical position to the power supply line 22 and the ground electrode 21 of the antenna element 2A in the direction of thickness of the dielectric layer 305 as a dielectric substrate.

An end of the power supply line 310 is electrically connected to an end of the power supply line 22 of the antenna element 2A by soldering or the like. As a result, radio frequency signals are transferred from the power supply line 310 of the wiring line portion 300 to the power supply line 22 of the antenna element 2A. With such a configuration, the wiring line portion 300 functions as a wiring section for transferring radio frequency signals from the power supply line 310 to the power supply line 22 of the antenna element 2A.

Ends of the pair of ground electrodes 320 are electrically connected to the pair of ends of the ground electrode 21 (a pair of electrode paths 2120) in the second region 212 of the antenna element 2A by soldering or the like. As a result, the ground electrodes 320 of the wiring line portion 300 and the ground electrode 21 of the antenna element 2A form the same conductor layer.

As described above, the antenna element 2A and the wiring line portion 300 are composed of separate dielectric substrates, and the ground electrode 21 of the antenna element 2A and the ground electrodes 320 of the wiring line portion 300 are arranged at the same position in the direction of thickness of the dielectric layer 305 as a dielectric substrate to form the same conductor layer. This makes it easy to match the impedance between the antenna element 2A and the wiring line portion 300, thereby reducing transmission loss.

### Sixth Embodiment

### Example of Connection Between Antenna Element 2B and Wiring Line Portion 300

In a sixth embodiment, an example of connection between the antenna element 2B illustrated in FIG. 4 and the wiring line portion 300 illustrated in FIG. 1 will be described.

FIG. 8 includes a plan view (FIG. 8(a)) and a side perspective view (FIG. 8(b)) of an example of connection between the antenna element 2B and the wiring line portion 300 in the sixth embodiment. The side perspective view in FIG. 8(b) is a side perspective view in the Y direction in the drawing, the side perspective view being obtained by cutting the antenna element 2B and the wiring line portion 300 in the Z-axis direction along a plane parallel to the line segment AB at a position where columnar electrodes 330 are formed on the ground electrode 320 in the front part in the Y direction in the wiring line portion 300.

The wiring line portion 300 has substantially the same configuration as the wiring line portion 300 illustrated in FIG. 7 and is formed on a dielectric substrate separate from the antenna element 2B. Regarding the wiring line portion 300 illustrated in FIG. 8, description of substantially the same configuration and variations as for the wiring line portion 300 illustrated in FIG. 7 is omitted as appropriate. The wiring line portion 300 includes a dielectric layer 305, a power supply line 310, a pair of ground electrodes 320, and a ground electrode GND. The dielectric layer 305 is a dielectric substrate formed of, for example, liquid crystal polymer (LCP). The dielectric layer 305 functions as a flexible cable with flexibility. The wiring line portion 300 does not have translucency. The pair of ground electrodes 320 are shaped electrodes with a notch portion 340 extending in the direction of extension of the pair of ground electrodes 320. In this manner, the pair of ground electrodes 320 constitute two electrode paths.

In the wiring line portion 300, the top surface 306 of the dielectric layer 305 is arranged at a position where the top surface 306 coincides with the top surface of the dielectric substrate 131. As a result, the power supply line 310 and the pair of ground electrodes 320 are arranged at an identical position to the power supply line 23 and the ground electrode 24 of the antenna element 2B in the direction of thickness of the dielectric layer 305 as a dielectric substrate.

An end of the power supply line 310 is electrically connected to an end of the power supply line 23 of the antenna element 2B by soldering or the like. As a result, radio frequency signals are transferred from the power supply line 310 of the wiring line portion 300 to the power supply line 23 of the antenna element 2B. With such a configuration, the wiring line portion 300 functions as a wiring section for transferring radio frequency signals from the power supply line 310 to the power supply line 23 of the antenna element 2B.

Ends of the pair of ground electrodes 320 are electrically connected to the pair of ends of the ground electrode 24 (a pair of electrode paths 2420) in the second region 242 of the antenna element 2B by soldering or the like. As a result, the ground electrodes 320 of the wiring line portion 300 and the ground electrode 24 of the antenna element 2B form the same conductor layer.

As described above, the antenna element 2B and the wiring line portion 300 are composed of separate dielectric substrates, and the ground electrode 24 of the antenna element 2B and the ground electrodes 320 of the wiring line portion 300 are arranged at the same position in the direction of thickness of the dielectric layer 305 as a dielectric substrate to form the same conductor layer. This makes it easy to match the impedance between the antenna element 2B and the wiring line portion 300, thereby reducing transmission loss.

### Seventh Embodiment

### Second Example of Arrayed Structure of Antenna Elements 2A

In a seventh embodiment, a second example of an arrayed structure of the antenna elements 2A illustrated in FIG. 2 will be described.

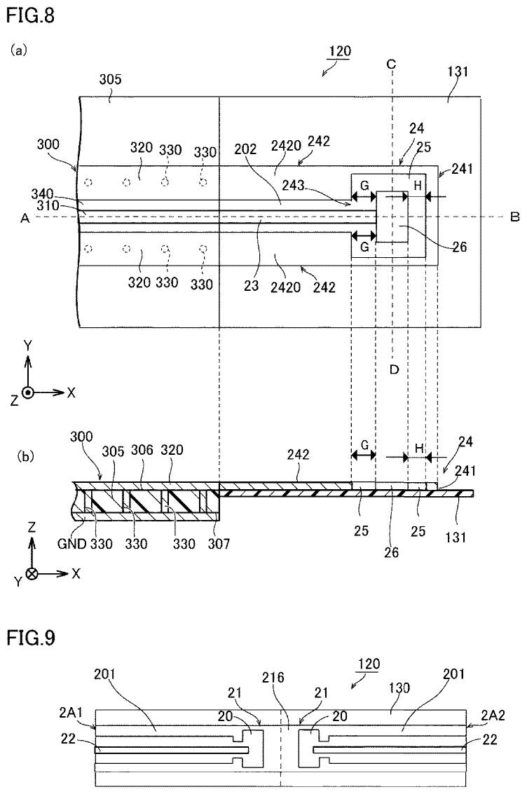

FIG. 9 is a plan view of the antenna elements 2A1 and 2A2 illustrating the second example of the arrayed structure of the antenna elements 2A in the seventh embodiment. FIG. 9 illustrates a typical example of a structure in which two adjacent antenna elements 2A, 2A1 and 2A2, are arrayed such that the slots 20 are oriented in the opposite directions. The dashed line is illustrated in the drawing to clarify the two antenna elements 2A1 and 2A2 as individual antenna element 2A units.

Referring to FIG. 9, in the case of the second example of the structure in which a plurality of antenna elements 2A are arrayed, regarding the antenna elements 2A1 and 2A2 to be arrayed, parts of the ground electrodes 21 illustrated in FIG. 2 are formed so as to be integrated with each other to form a ground electrode portion 216. Specifically, the ground electrode portion 216 is formed by forming the end portions of the facing first regions 211 so as to be integrated with each other between the facing antenna elements 2A1 and 2A2. Each antenna element 2A in the structure in which the antenna elements 2A as illustrated in FIG. 9 are arrayed is connected to the wiring line portion 300 in, for example, a connection format as illustrated in FIG. 7.

In the case of the second example in which the plurality of antenna elements 2A are arrayed as illustrated in FIG. 9, substantially the same effects as in the case of the first example in which the plurality of antenna elements 2A are arrayed as illustrated in FIG. 5 can be achieved.

### Eighth Embodiment

### Second Example of Arrayed Structure of Antenna Elements 2B

In an eighth embodiment, a second example of an arrayed structure of the antenna elements 2B illustrated in FIG. 4 will be described.

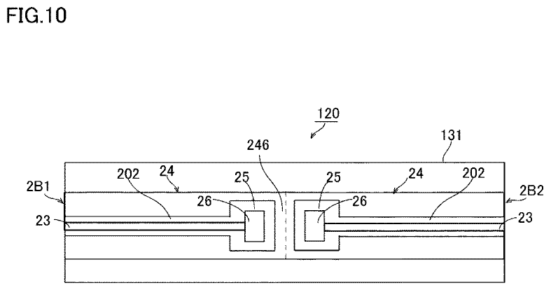

FIG. 10 is a plan view of the antenna elements 2B1 and 2B2 illustrating the second example of the arrayed structure of the antenna elements 2B in the eighth embodiment. FIG. 10 illustrates a typical example of a structure in which two adjacent antenna elements 2B, 2B1 and 2B2, are arrayed such that the patches 26 are oriented in the opposite directions. The dashed line is illustrated in the drawing to clarify the two antenna elements 2B1 and 2B2 as individual antenna element 2B units.

Referring to FIG. 10, in the case of the second example of the structure in which a plurality of antenna elements 2B are arrayed, regarding the antenna elements 2B1 and 2B2 to be arrayed, parts of the ground electrodes 24 illustrated in FIG. 4 are formed so as to be integrated with each other to form a ground electrode portion 246. Specifically, the ground electrode portion 246 is formed by forming the end portions of the facing first regions 241 so as to be integrated with each other between the antenna elements 2B1 and 2B2. Each antenna element 2B in the structure in which the antenna elements 2B as illustrated in FIG. 10 are arrayed is connected to the wiring line portion 300 in, for example, a connection format as illustrated in FIG. 8.

In the case of the second example in which the plurality of antenna elements 2B are arrayed as illustrated in FIG. 10, substantially the same effects as in the case of the first example in which the plurality of antenna elements 2B are arrayed as illustrated in FIG. 6 can be achieved.

### Other Modifications

Next, other modifications of the embodiments according to the present disclosure will be described.

(1) Regarding the antenna elements 2A and 2B, the example in which the ground electrodes 21 and 24 and the power supply lines 22 and 23 have mesh shapes has been described in the first to eighth embodiments. However, not limited to this, the ground electrodes 21 and 24 and the power supply lines 22 and 23 may have shapes other than mesh shapes.

(2) Regarding the antenna elements 2A and 2B, the example in which the dielectric substrates 130 and 131 are substrates having translucency has been described in the first to eighth embodiments. However, not limited to this, substrates that do not have translucency may be used as the dielectric substrates 130 and 131.

(3) Regarding the antenna elements 2A and 2B, the example in which the dielectric substrates 130 and 131 are film substrates has been described in the first to eighth embodiments. However, not limited to this, dielectric substrates having configurations other than film substrates may be used as the dielectric substrates 130 and 131.

(4) In the fifth and sixth embodiments, the wiring line portion 300 is described as a flexible cable including the dielectric layer 305, the power supply line 310, the ground electrodes 320, and the ground electrode GND. However, not limited to this, the wiring line portion 300 may be a film dielectric substrate on which a power supply line and ground electrodes are formed. Such a film dielectric substrate may be translucent or non-translucent.

(5) In the fifth embodiment, the wiring line portion 300 is described as being formed on a substrate separate from the dielectric substrate 130 of the antenna element 2A. In the sixth embodiment, the wiring line portion 300 is described as being formed on a dielectric substrate separate from the dielectric substrate 131 of the antenna element 2B. However, not limited to this, the dielectric substrate of the wiring line portion 300 may be formed so as to be integrated with each of these dielectric substrates 130 and 131. In a case where the substrate of the wiring line portion 300 and the dielectric substrate of the antenna elements 2 are formed as a single substrate in this manner, the substrate may be a film substrate as described above or may also be a dielectric substrate that functions as a flexible cable as described above.

### Summary of Embodiments

Next, a summary of the features of the embodiments according to the present disclosure will be described.

(1) As illustrated in FIG. 2 and so forth, the width E of each protrusion 2110 of the ground electrode 21 in the first direction from the slot 20 is different from the width F of the ground electrode 21 in the second direction from the slot 20 in the slot-type antenna element 2A. Thus, regarding radio waves to be radiated from the slot 20, even in a case where there is no symmetry between the shapes of the ground electrode 21 and the power supply line 22, the symmetry of the radiation characteristics of radio waves in the Z-axis direction can be improved for radio waves to be radiated.

(2) As illustrated in FIG. 7 and so forth, the antenna element 2A and the wiring line portion 300 are composed of separate dielectric substrates, and the ground electrode 21 of the antenna element 2A and the ground electrodes 320 of the wiring line portion 300 are arranged at the same position in the direction of thickness of the dielectric layer 305 as a dielectric substrate to form the same conductor layer. This makes it easy to match the impedance between the antenna element 2A and the wiring line portion 300, thereby reducing transmission loss.

(3) As described using FIG. 2 and so forth, since the dielectric substrate 130 is in the form of a transparent film and has translucency in the antenna element 2A, it is possible to make it difficult to confirm the presence of the dielectric substrate 130 with the naked eye.

(4) As illustrated in FIG. 3 and so forth, since the ground electrode 21 and the power supply line 22 in the antenna element 2A are configured so as to have mesh shapes that make it difficult to confirm their presence with the naked eye when viewed in a plan view, it is possible to make it difficult to confirm the presence of the ground electrode 21 and the power supply line 22 with the naked eye.

(5) As described using FIG. 7 and so forth, the wiring line portion 300 is formed on a dielectric substrate separate from the dielectric substrate 130 of the antenna element 2A. The power supply line 310 and the ground electrodes 320 form coplanar lines. Moreover, the power supply line 310 and the ground electrode GND may be used to form a strip line or a microstrip line. By forming such coplanar lines, such a strip line, or such a microstrip line, high-speed transmission lines can be formed.

(6) As illustrated in FIG. 5 and so forth, with a configuration in which a plurality of antenna elements 2A are arrayed, the width E of each protrusion 2110 of the ground electrode 21 in the first direction from the slot 20 is different from the width F of the ground electrode 21 in the second direction from the slot 20 in the ground electrode 21 of each of the plurality of antenna elements 2A1 and 2A2. Thus, even in a case where there is no symmetry between the shapes of the ground electrode 21 and the power supply line 22, the symmetry of the radiation characteristics of radio waves in the Z-axis direction can be improved for radio waves to be radiated from the slot 20. Furthermore, the array of the plurality of antenna elements 2A1 and 2A2 can suppress, over a wide range, noise radiated from elements and circuits provided in the downward direction from the arrayed antenna elements 2A1 and 2A2.

(7) As illustrated in FIG. 5 and so forth, with a configuration in which a plurality of antenna elements 2A are arrayed, regarding an array of a plurality of antenna elements 2A1 and 2A2, the size of the array of the plurality of antenna elements 2A1 and 2A2 can be reduced by forming the ground electrode portion 215, which is formed by forming parts of the ground electrodes 21 so as to be integrated with each other.

(8) As illustrated in FIG. 4 and so forth, the distance G between the patch 26 and the ground electrode 24 in the first direction from the patch 26 is different from the distance H between the patch 26 and the ground electrode 24 in the second direction from the patch 26 in the patch-type antenna element 2B. Thus, regarding radio waves to be radiated from the patch 26, even in a case where there is no symmetry between the shapes of the ground electrode 24 and the power supply line 23, the symmetry of the radiation characteristics of radio waves in the Z-axis direction can be improved for the radio waves to be radiated.

(9) As illustrated in FIG. 8 and so forth, the antenna element 2B and the wiring line portion 300 are composed of separate dielectric substrates, and the ground electrode 24 of the antenna element 2B and the ground electrodes 320 of the wiring line portion 300 are arranged at the same position in the direction of thickness of the dielectric layer 305 as a dielectric substrate to form the same conductor layer. This makes it easy to match the impedance between the antenna element 2B and the wiring line portion 300, thereby reducing transmission loss.

(10) As described using FIG. 4 and so forth, since the dielectric substrate 131 is in the form of a transparent film and has translucency in the antenna element 2B, it is possible to make it difficult to confirm the presence of the dielectric substrate 131 with the naked eye.

(11) As illustrated in FIG. 3 and so forth, since the ground electrode 24 and the power supply line 23 in the antenna element 2B are configured so as to have mesh shapes that make it difficult to confirm their presence with the naked eye when viewed in a plan view, it is possible to make it difficult to confirm the presence of the ground electrode 24 and the power supply line 23 with the naked eye.

(12) As described using FIG. 8 and so forth, the wiring line portion 300 is formed on a dielectric substrate separate from the dielectric substrate 131 of the antenna element 2B. The power supply line 310 and the ground electrodes 320 form coplanar lines. Moreover, the power supply line 310 and the ground electrode GND may be used to form a strip line or a microstrip line. By forming such coplanar lines, such a strip line, or such a microstrip line, high-speed transmission lines can be formed.

(13) As illustrated in FIG. 6 and so forth, with a configuration in which a plurality of antenna elements 2B are arrayed, the distance G between the patch 26 and the ground electrode 24 in the first direction from the patch 26 is different from the distance H between the patch 26 and the ground electrode 24 in the second direction from the patch 26 in the ground electrode 24 of each of the plurality of antenna elements 2B1 and 2B2. Thus, even in a case where there is no symmetry between the shapes of the ground electrode 24 and the power supply line 23, the symmetry of the radiation characteristics of radio waves in the Z-axis direction can be improved for radio waves to be radiated from the patch 26. Furthermore, the array of the plurality of antenna elements 2B1 and 2B2 can suppress, over a wide range, noise radiated from elements and circuits provided in the downward direction from the arrayed antenna elements 2B1 and 2B2.

(14) As illustrated in FIG. 6 and so forth, with a configuration in which a plurality of antenna elements 2B are arrayed, regarding an array of a plurality of antenna elements 2B1 and 2B2, the size of the array of the plurality of antenna elements 2B1 and 2B2 can be reduced by forming the ground electrode portion 215, which is formed by forming parts of the ground electrodes 24 so as to be integrated with each other.

(15) As illustrated in FIG. 2 and so forth, the first region 211 of the ground electrode 21 where the slot 20 is formed is provided on the dielectric substrate 130 in a shape that does not extend to the end portion of the dielectric substrate 130 in the horizontal direction (the X direction) and the vertical direction (the Y direction) of the dielectric substrate 130. This suppresses generation of unwanted radio waves, thus reducing degradation of antenna characteristics.

The embodiments disclosed this time should be considered exemplary and not restrictive in all respects. The scope of the present disclosure is indicated not by the above-described description of the embodiments but by the claims and is intended to include all changes within the meaning and scope of the claims and equivalents.

### Reference Signs List

130, 131 dielectric substrate, 21, 24, 320 ground electrode, 22, 23, 310 power supply line, 20, 25 slot, 201, 202 notch portion, 2110 protrusion, 300 wiring line portion, 305 dielectric layer, 26 patch, 100 antenna module

1. An antenna module comprising:
a first dielectric substrate, which is planar;
a first ground electrode that is provided on the first dielectric substrate and in which a first slot and a first notch portion are formed, the first notch portion extending in a first direction from the first slot; and
a first power supply line that is provided on the first dielectric substrate and extends through the first notch portion in the first direction and that transfers a radio frequency signal into the first slot, wherein
the first power supply line is arranged at an identical position to the first ground electrode in a direction of thickness of the first dielectric substrate,
the first ground electrode has a first protrusion projecting between the first slot and the first notch portion, and
a width of the first protrusion in the first direction is different from a width of the first ground electrode in a second direction opposite to the first direction.

2. The antenna module according to claim 1 further comprising:
a wiring section that transfers a radio frequency signal to the first power supply line, wherein
the wiring section includes
a second dielectric substrate,
second ground electrodes that are provided on the second dielectric substrate and are connected to the first ground electrode, and
a second power supply line that is connected to the first power supply line, wherein
the second ground electrodes are arranged at an identical position to the first ground electrode in a direction of thickness of the second dielectric substrate.

3. The antenna module according to claim 1, wherein the first dielectric substrate has translucency.

4. The antenna module according to claim 1, wherein the first ground electrode and the first power supply line have mesh shapes.

5. The antenna module according to claim 2, wherein the second power supply line and the second ground electrodes form coplanar lines.

6. The antenna module according to claim 1 comprising:
a third ground electrode that is provided on the first dielectric substrate and in which a second slot and a second notch portion are formed, the second notch portion extending in the first direction from the second slot; and
a third power supply line that is provided on the first dielectric substrate, extends through the second notch portion in the first direction, and transfers a radio frequency signal into the second slot, wherein
the third power supply line is arranged at an identical position to the third ground electrode in the direction of thickness of the first dielectric substrate,
the third ground electrode has a second protrusion projecting between the second slot and the second notch portion, and
a width of the second protrusion in the first direction is different from a width of the third ground electrode in the second direction.

7. The antenna module according to claim 6, wherein
the first ground electrode and the first power supply line are arranged adjacent to the third ground electrode and the third power supply line, and
part of the first ground electrode is formed so as to be integrated with the third ground electrode.

8. An antenna module comprising:
a first dielectric substrate, which is planar;
a first ground electrode that is provided on the first dielectric substrate and in which a first slot and a first notch portion are formed, the first notch portion extending in a first direction from the first slot;
a first radiating element arranged in the first slot; and
a first power supply line that is provided on the first dielectric substrate and extends through the first notch portion in the first direction and that transfers a radio frequency signal to the first radiating element, wherein
the first power supply line is arranged at an identical position to the first ground electrode in a direction of thickness of the first dielectric substrate, and
a distance between the first ground electrode and the first radiating element in the first direction from the first radiating element is different from a distance between the first ground electrode and the first radiating element in a second direction opposite to the first direction, and
a third ground electrode that is provided on the first dielectric substrate and in which a second slot and a second notch portion are formed, the second notch portion extending in the first direction from the second slot;
a second radiating element arranged in the slot; and
a third power supply line that is provided on the first dielectric substrate and extends through the second notch portion in the first direction and that transfers a radio frequency signal to the second radiating element, wherein
the third power supply line is arranged at an identical position to the third ground electrode in the direction of thickness of the first dielectric substrate, and
a distance between the third ground electrode and the second radiating element in the first direction from the second radiating element is different from a distance between the third ground electrode and the second radiating element in the second direction.

9. The antenna module according to claim 8 further comprising:
a wiring section that transfers a radio frequency signal to the first power supply line, wherein
the wiring section includes
a second dielectric substrate,
second ground electrodes that are provided on the second dielectric substrate and are connected to the first ground electrode, and
a second power supply line that is connected to the first power supply line, wherein
the second ground electrodes are arranged at an identical position to the first ground electrode in a direction of thickness of the second dielectric substrate.

10. The antenna module according to claim 8, wherein the first dielectric substrate has translucency.

11. The antenna module according to claim 8, wherein the first ground electrode and the first power supply line have mesh shapes.

12. The antenna module according to claim 9, wherein the second power supply line and the second ground electrodes form coplanar lines.

13. The antenna module corresponding to claim 8, wherein
the first ground electrode and the first power supply line are arranged adjacent to the third ground electrode and the third power supply line, and
part of the first ground electrode is formed so as to be integrated with the third ground electrode.

14. The antenna module corresponding to claim 9, wherein
the first ground electrode and the first power supply line are arranged adjacent to the third ground electrode and the third power supply line, and
part of the first ground electrode is formed so as to be integrated with the third ground electrode.

15. The antenna module according to claim 10 further comprising:
a wiring section that transfers a radio frequency signal to the first power supply line, wherein
the wiring section includes
a second dielectric substrate,
second ground electrodes that are provided on the second dielectric substrate and are connected to the first ground electrode, and
a second power supply line that is connected to the first power supply line, wherein
the second ground electrodes are arranged at an identical position to the first ground electrode in a direction of thickness of the second dielectric substrate.

16. The antenna module according to claim 10, wherein the first dielectric substrate has translucency.

17. The antenna module according to claim 10, wherein the first ground electrode and the first power supply line have mesh shapes.

18. The antenna module according to claim 17, wherein the second power supply line and the second ground electrodes form coplanar lines.

19. The antenna module according to claim 13, wherein the first ground electrode and the first power supply line have mesh shapes.

20. The antenna module according to claim 19, wherein the second power supply line and the second ground electrodes form coplanar lines.
